(19) United States
(12) Patent Application Publication
(10) Pub. No.: US 2018/0290348 A1
(43) Pub. Date: Oct. 11, 2018

(54) METHOD FOR MANUFACTURING A FOAMED FABRIC

(71) Applicant: LI CHENG ENTERPRISE CO., LTD., Yun-Lin Hsien (TW)

(72) Inventor: Yi-Song SU, Yun-Lin Hsien (TW)

(21) Appl. No.: 15/646,670

(22) Filed: Jul. 11, 2017

(30) Foreign Application Priority Data
Apr. 11, 2017 (TW) 106112004

(51) Int. Cl. B29C 44/34; D06P 7/00; D06P 5/20; D06P 3/82; D06P 1/94

(52) U.S. Cl. CPC B29C 44/3403; D06P 7/00; D06P 3/52; D06P 3/8214; D06P 1/94; D06P 5/2055

(57) ABSTRACT

A method for manufacturing a foamed fabric includes providing a fabric which includes at least one layer including a plurality of first foamable filaments made from a first foamable polymeric material, infusing the fabric with a supercritical fluid in a pressurized vessel, subjecting the infused fabric to a depressurizing process to permit the at least one layer to undergo an initial stage of foaming so as to obtain a pre-foamed fabric, placing the pre-foamed fabric in a mold cavity, and heating the mold cavity to obtain a molded foamed fabric.

### FIELD OF THE INVENTION

The disclosure relates to a method for manufacturing a foamed fabric, and more particularly to a method for manufacturing a foamed fabric using a supercritical fluid.

### BACKGROUND OF THE INVENTION

It is generally necessary for conventional preparation and processing of polymeric materials to use a large amount of solvent and/or plasticizer, which may however have a negative impact on the environment. In order to meet environmental protection requirements, a supercritical fluid is often used as an alternative to the solvent and/or plasticizer. The supercritical fluid may be used for polymerization, modification, blending, foaming, and dyeing of polymeric materials.

The supercritical fluid has been used for foaming a thermoplastic elastomer article. For example, US 2014/0259753 Al discloses a method of foaming an article comprising a thermoplastic elastomer. The method comprises: infusing the article with a supercritical fluid, removing the article from the supercritical fluid, and either (i) immersing the article in a heated fluid or (ii) irradiating the article with infrared or microwave radiation to make a foamed article. The article comprises a nonpolar component. The nonpolar component is used to increases an amount of the supercritical fluid infused in the article. The method may be used for making, for example, a midsole.

In addition, the supercritical fluid is used for dyeing textile materials. For example, U.S. Pat. No. 6,620,211 B2 discloses a method for dyeing a textile material with one or more fiber-reactive disperse dyestuffs in a supercritical fluid.

In addition to diverseness in color of a fabric, it is desirable in the art of textile to provide more diverse profiles for a fabric.

### SUMMARY OF THE INVENTION

An object of the disclosure is to provide a method for manufacturing a foamed fabric using a supercritical fluid so as to provide the foamed fabric with a three-dimensional profile.

According to the disclosure, there is provided a method for manufacturing a foamed fabric, comprising:
a) providing a fabric which includes at least one layer including a plurality of first foamable filaments made from a first foamable polymeric material;
b) infusing the fabric with a supercritical fluid in a pressurized vessel;
c) subjecting the infused fabric to a depressurizing process to permit the at least one layer to undergo an initial stage of foaming so as to obtain a pre-foamed fabric;
d) placing the pre-foamed fabric in a mold cavity; and
e) heating the mold cavity to obtain a molded foamed fabric.

### DETAILED DESCRIPTION

An embodiment of a method for manufacturing a foamed fabric according to the present disclosure comprises:
a) providing a fabric which includes at least one layer including a plurality of first foamable filaments made from a first foamable polymeric material;
b) infusing the fabric with a supercritical fluid in a pressurized vessel;
c) subjecting the infused fabric to a depressurizing process to permit the at least one layer to undergo an initial stage of foaming so as to obtain a pre-foamed fabric;
d) placing the pre-foamed fabric in a mold cavity; and
e) heating the mold cavity to obtain a molded foamed fabric.

In certain embodiments, the at least one layer further includes a plurality of second foamable filaments which are made from a second foamable polymeric material and which are woven with the first foamable filaments. In certain embodiments, the first foamable polymeric material has foamability different from that of the second foamable polymeric material. In certain embodiments, the foamability of the first foamable polymeric material is higher than that of the second foamable polymeric material.

The fabric may be in a form of a single-layered configuration or a multi-layered configuration. The single-layered configuration is formed by interweaving the first foamable filaments and the second foamable filaments. The multi-layered configuration may be a double-layered configuration, a triple-layered configuration, or the like. The double-layered configuration may include a base layer formed by weaving the second foamable filaments and a foamable layer formed by interweaving the first foamable filaments and the second foamable filaments. The triple-layered configuration may include a base layer, a top layer, and a middle layer disposed between the base layer and the top layer. At least one of the base layer, the top layer, and the middle layer is formed by interweaving the first foamable filaments and the second foamable filaments.

The term “foamable filaments” means any filaments which are foamable and which are made from a foamable polymeric material. The foamable filaments may have a construction of a core-sheath type, a hollow type, a cross-section type, or the like. Examples of the foamable polymeric material include, but are not limited to, polystyrene, polycarbonate, polyurethane, acrylonitrile-butadiene-styrene copolymer, polyimide, polyamide, polyphenylene sulfide, polyether sulfone, polyvinyl chloride, natural rubber, silicone rubber, nitrile rubber, polypropylene, polyethylene, polylactic acid, and polyethylene terephthalate. These polymers may be used alone or in admixture of two or more.

The supercritical fluid is formed from a fluid at a temperature higher than a supercritical temperature under a pressure higher than a supercritical pressure and is then introduced into the pressurized vessel. In certain embodiments, the fluid for forming the supercritical fluid is carbon dioxide. In certain embodiments, the supercritical fluid is formed from carbon dioxide at a heating temperature under a pressurized atmosphere so as to increase the amount of the supercritical fluid introduced into the pressurized vessel. In addition, the thermal energy produced at the heating temperature may enhance the infusion of the supercritical fluid into the foamable filaments so as to increase the infusion amount of the supercritical fluid in the foamable filaments. In certain embodiments, the supercritical fluid is formed at a temperature ranging from 90° C. to 180° C. under a pressurized atmosphere. When the supercritical fluid is formed at a temperature below 90° C., the initial stage of foaming the infused fabric may be insufficient. On the other hand, when the supercritical fluid is formed at a temperature above 180° C., the pre-foamed fabric thus formed may have problems of uneven foaming, collapsing, and the like. In certain embodiments, the supercritical fluid is formed at a temperature ranging from 90° C. to 130° C. under a pressurized atmosphere.

In certain embodiments, the pressurized atmosphere is in a range from 8 MPa to 25 MPa.

In certain embodiments, the supercritical fluid contains a dye dispersed or dissolved therein so as to impart the dye to the infused fabric. In certain embodiments, the dye is coated onto a carrier to form a dye-coated carrier dispersed in the supercritical fluid. The dye may be coated onto the carrier by, for example, roller coating, electrostatic coating, foam coating, spray coating, or the like. Examples of the carrier include, but are not limited to, films, textiles, activated carbons, and polymeric solids.

It should noted that when the supercritical fluid which contains the dye dispersed or dissolved therein is formed at the temperature ranging from 90° C. to 180° C., the thermal energy produced at the temperature may enhance the infusion of the supercritical fluid together with the dye into the foamable filaments so as to increase the amount of the dye introduced into the foamable filaments.

In certain embodiments, the supercritical fluid may further contains aids commonly used in the art. Examples of the aids include, but are not limited to, nucleating agents and cosolvents. Examples of the nucleating agents include, but are not limited to, nano-clay and carbon black. Examples of the cosolvents include, but are not limited to, alcohols, such as methanol, ethanol, and isopropanol, and ionic liquid.

In certain embodiments, the depressurizing process for obtaining the pre-foamed fabric is performed by reducing the pressure in the pressurized vessel to a pressure of 1 atm.

In certain embodiments, the mold cavity is heated at a temperature ranging from 90° C. to 180° C. by using, for example, microwave, infrared, steam, electric heating, and the like. The period for heating the mold cavity may be adjusted according to specific requirements. In certain embodiments, the period for heating the mold cavity is in a range from 20 seconds to 1500 seconds.

Examples of the disclosure will be described hereinafter. It is to be understood that these examples are exemplary and explanatory and should not be construed as a limitation to the disclosure.

### EXAMPLE 1

### Manufacture of a Foamed Fabric

A plurality of thermoplastic polyurethane yarns and a plurality of polyester fully oriented yarns were interwoven using a weaving machine to form a triple-layered fabric including a base layer, a top layer, and a middle layer disposed between the base layer and the top layer. The top layer was in an amount of 35 wt %, the middle layer was in an amount of 30 wt %, and the base layer was in an amount of 35 wt % based on a total weight of the triple-layered fabric. The top layer was formed from the thermoplastic polyurethane yarns. Both of the middle layer and the base layer were formed from the polyester fully oriented yarns.

Carbon dioxide was passed through a metering pump set at a pressure of 10 MPa and a heating device set at a temperature of 110° C. to transform carbon dioxide into a supercritical fluid. The supercritical fluid was introduced into a pressurized vessel in which the triple-layered fabric was placed. The triple-layered fabric was infused with the supercritical fluid in the pressurized vessel at a temperature of 110° C. for a period of 120 minutes to obtain an infused fabric. It was found that the top layer formed from the thermoplastic polyurethane yarns has a supercritical fluid infusion amount higher than those of the middle layer and the base layer formed from the polyester fully oriented yarns.

The infused fabric was subjected to a depressurizing process by reducing the pressure in the pressurized vessel to a normal pressure to permit the yarns to undergo an initial stage of foaming so as to obtain a pre-foamed fabric.

The pre-foamed fabric was placed in a mold cavity. The mold cavity was then heated to obtain a molded foamed fabric.

### EXAMPLE 2

### Manufacture of a Foamed and Dyed Fabric

A plurality of thermoplastic polyurethane yarns and a plurality of polyester drawn textured yarns were interwoven using a weaving machine to form a triple-layered fabric including a base layer, a top layer, and a middle layer disposed between the base layer and the top layer. The top layer was in an amount of 55 wt %, the middle layer was in an amount of 20 wt %, and the base layer was in an amount of 25 wt % based on a total weight of the triple-layered fabric. Both of the top layer and the base layer were formed from the polyester drawn textured yarns. The middle layer was formed from the thermoplastic polyurethane yarns.

Carbon dioxide was passed through a metering pump set at a pressure of 10 MPa and a heating device set at a temperature of 110° C. to transform carbon dioxide into a supercritical fluid. The supercritical fluid was introduced into a pressurized vessel in which the triple-layered fabric and dye-coated carriers were placed. The dye-coated carriers were previously formed by coating a dye onto carriers via electrostatic coating. The triple-layered fabric was infused with the supercritical fluid in the pressurized vessel at a temperature of 110° C. for a period of 120 minutes to obtain an infused fabric.

The infused fabric was subjected to a depressurizing process by reducing the pressure in the pressurized vessel to a normal pressure to permit the yarns to undergo an initial stage of foaming so as to obtain a pre-foamed and dyed fabric.

The pre-foamed and dyed fabric was placed in a mold cavity. The mold cavity was then heated to obtain a molded foamed and dyed fabric.

### Measurements:

The molded foamed fabric obtained in Example 1 and the molded foamed and dyed fabric obtained in Example 2 were measured for cell density and cell diameter as follows. The molded foamed and dyed fabric obtained in Example 2 was further measured for color fastness as follows. The measurement results are shown in Table 1 below.
1. Cell density (cells/cm³): A scanning electron microscope was used for observation and measurement.
2. Cell diameter (μm): A scanning electron microscope was used for observation and measurement.
3. Color fastness:
   (1) Color fastness to perspiration: Measurement was performed according to a standard test method (ISO 105 E04). Commercially acceptable color fastness to perspiration is at least level 3.
   (2) Color fastness to water: Measurement was performed according to a standard test method (ISO 105 E01). Commercially acceptable color fastness to water is at least level 3.
   (3) Color fastness to organic solvent: Measurement was performed according to a standard test method (ISO 105 X05). Commercially acceptable color fastness to organic solvent is at least level 3.
   (4) Color fastness to washing: Measurement was performed according to a standard test method (ISO 105 C06). Commercially acceptable color fastness to washing is at least level 3.
   (5) QUV color fastness: Measurement was performed according to a standard test method (ISO 105 E01). Commercially acceptable color fastness to QUV is at least level 3.
   (6) Phenolic yellowing: Measurement was performed according to a standard test method (ISO 105 X18). Commercially acceptable phenolic yellowing is at least level 3.

TABLE 1

| | | Ex. 1 | Ex. 2 |
|---|---|---|---|
| | Cell density (×10⁷ cells/cm³) | 2.52 | 50 |
| | Cell diameter (μm) | 35.5 | 35.7 |
| Color | Color fastness to perspiration | — | Level 3 |
| fastness | Color fastness to water | — | Level 3 |
| | Color fastness to organic solvent | — | Level 3 |
| | Color fastness to washing | — | Level 3 |
| | Color fastness to QUV | — | Level 3 |
| | Phenolic yellowing | — | Level 3 |

It can be seen from Table 1 above that the method for manufacturing a foamed fabric according the disclosure may be used for manufacturing a foamed fabric or a foamed and dyed fabric which has a commercially acceptable color fastness.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing a foamed fabric, comprising:
a) providing a fabric which includes at least one layer including a plurality of first foamable filaments made from a first foamable polymeric material;
b) infusing the fabric with a supercritical fluid in a pressurized vessel;
c) subjecting the infused fabric to a depressurizing process to permit the at least one layer to undergo an initial stage of foaming so as to obtain a pre-foamed fabric;
d) placing the pre-foamed fabric in a mold cavity; and
e) heating the mold cavity to obtain a molded foamed fabric.

2. The method according to claim 1, wherein in b), the supercritical fluid is formed at a temperature ranging from 90° C. to 180° C. under a pressurized atmosphere.

3. The method according to claim 1, wherein in b), the supercritical fluid contains a dye dispersed or dissolved therein so as to impart the dye to the infused fabric.

4. The method according to claim 3, wherein the dye is coated onto a carrier to form a dye-coated carrier dispersed in the supercritical fluid.

5. The method according to claim 1, wherein in a), the at least one layer further includes a plurality of second foamable filaments which are made from a second foamable polymeric material and which are woven with the first foamable filaments.

6. The method according to claim 5, wherein the first foamable polymeric material has foamability different from that of the second foamable polymeric material.

7. The method according to claim 2, wherein the pressurized atmosphere is in a range from 8 MPa to 25 MPa.

8. The method according to claim 1, wherein in e), the mold cavity is heated at a temperature ranging from 90° C. to 180° C.
